(19) United States
(12) Patent Application Publication
(10) Pub. No.: US 2005/0138296 A1
(43) Pub. Date: Jun. 23, 2005

(54) Method and system to alter a cache policy

(76) Inventors: Richard L. Coulson, Portland, OR (US); Robert J. Royer JR., Portland, OR (US); Brian A. Leete, Beaverton, OR (US)

Correspondence Address: INTEL CORPORATION, P.O. BOX 5326, SANTA CLARA, CA, 95056-5326, US

(21) Appl. No.: 10/740,736

(22) Filed: Dec. 18, 2003

(51) Int. Cl. G06F 12/00

(52) U.S. Cl. 711/141; 711/113; 711/137; 711/143

(57) ABSTRACT

Briefly, in accordance with an embodiment of the invention, a system and method to alter a cache policy of the system in response to the system transitioning from a first power state to a second power state is provided. The system may include a non-volatile disk cache and a disk memory, wherein the cache policy is used by the non-volatile disk cache to cache information for the disk memory.

### BACKGROUND

Portable or mobile computing systems such as, for example, laptop or notebook computers, may be powered using either a direct current (DC) power source (e.g., a battery) or an alternating current (AC) power source (e.g., 60 Hz AC supplied by power lines). In order to reduce power consumption and increase battery life, some portable computers automatically dim their display. System designers are continually searching for more ways to reduce power consumption while the portable computers operate using battery power.

Thus, there is a continuing need for alternate ways to reduce power consumption in portable computing systems.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a block diagram illustrating a system in accordance with an embodiment of the present invention;

FIG. 2 is a flow diagram illustrating a method in accordance with an embodiment of the present invention;

FIG. 3 is a flow diagram illustrating a method in accordance with an embodiment of the present invention;

FIG. 4 is a flow diagram illustrating a method in accordance with an embodiment of the present invention; and

FIG. 5 is a flow diagram illustrating a method in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the term “information” may be used to refer to data, instructions, or code.

In addition, in the following description and claims, the terms “coupled” and “connected,” along with their derivatives may be used, and these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

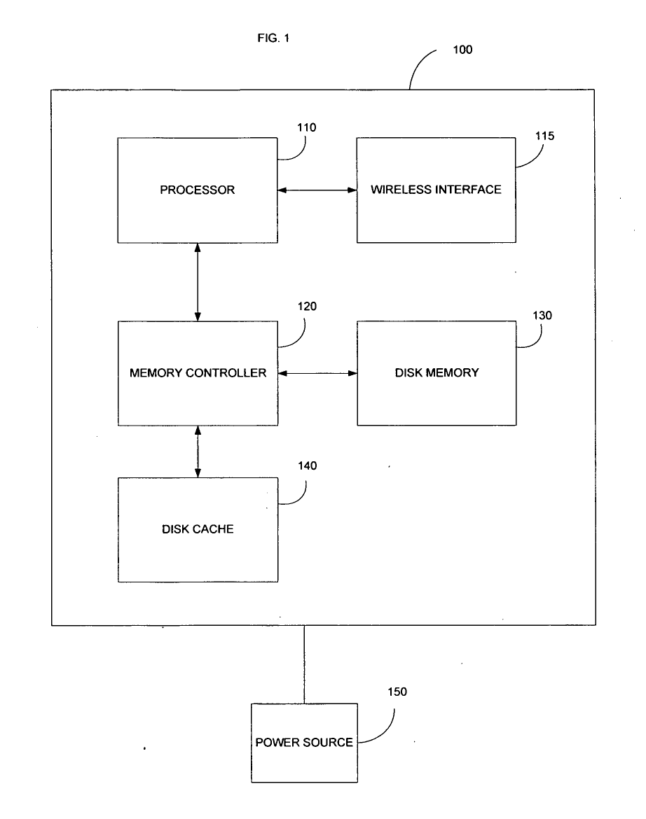

FIG. 1 is a block diagram illustrating a system 100 in accordance with an embodiment of the present invention. In this embodiment, system 100 may be a computing system and may include a processor 110, which may include one or more general-purpose or special-purpose processors such as, e.g., a microprocessor, microcontroller, application specific integrated circuit (ASIC), a programmable gate array (PGA), a digital signal processor (DSP), or the like. System 100 may also be referred to as a data processing system or simply as a computer in some embodiments.

A wireless interface 1 15 may be coupled to processor 1 10. Wireless interface 115 may include a wireless transceiver (not shown) coupled to an antenna (not shown). Wireless interface 1 15 may allow system 100 to communicate information wirelessly to other devices or a network. System 100 may be adapted to use one or more wireless protocols such as, for example, a wireless personal area network (WPAN) protocol, a wireless local area network (WLAN) protocol, a wireless metropolitan area network (WMAN) protocol, or a wireless wide area network (WWAN) system such as, for example, a cellular system.

An example of a WLAN protocol includes a protocol substantially based on an Industrial Electrical and Electronics Engineers (IEEE) 802.11 protocol. An example of a WMAN protocol includes a system substantially based on an Industrial Electrical and Electronics Engineers (IEEE) 802.16 protocol. An example of a WPAN protocol includes a system substantially based on the Bluetooth™ standard (Bluetooth is a registered trademark of the Bluetooth Special Interest Group). Another example of a WPAN protocol includes a ultrawideband (UWB) protocol, e.g., a protocol substantially based on the IEEE 802.15.3a specification.

Processor 110 may be coupled to memory controller 120, which may be referred to as a memory controller hub (MCH) in some embodiments. A disk memory 130 and a disk cache 140 may be coupled to memory controller 120. Disk cache 140 may be used to cache information for disk memory 130. Examples of cache policies or cache algorithms used by disk cache 140 are discussed below. The access time of disk cache 140, i.e., the amount of time it takes to complete a read or write request, may be less than the access time of disk memory 130. System performance may be improved by using disk cache 140 to cache information for disk memory 130.

Memory controller 120 may control the transfer of information between processor 110, memory controller 120, disk cache 140, and disk memory 130. That is, memory controller 120 may generate control signals, address signals, and data signals that may be associated with a particular write or read operation to disk cache 140 and disk memory 130.

In some embodiments, memory controller 120 may be integrated (“on-chip”) with processor 110 and/or with disk cache 140. In alternate embodiments, memory controller 120 may be a discrete component or dedicated chip, wherein memory controller 120 is external (“off-chip”) to processor 110 and disk cache 140. In addition, processor 1 10 and disk cache 140 may be discrete components. In other embodiments, portions of the functionality of memory controller 120 may be implemented using software.

In one embodiment, disk cache 140 may be a non-volatile disk cache such as, e.g., a non-volatile polymer disk cache memory. For example, disk cache 140 may be a ferroelectric polymer memory that may include an array of ferroelectric memory cells, wherein each cell may include a ferroelectric polymer memory material located between at least two conductive lines. The conductive lines may be referred to as address lines and may be used to apply an electric field across the ferroelectric polymer material to alter the polarization of the polymer material.

In this embodiment, disk cache 140 may utilize the ferroelectric behavior of certain materials to retain data in a memory device in the form of positive and negative polarization, even in the absence of electric power. The ferroelectric polarizable material of each cell may contain domains of similarly oriented electric dipoles that retain their orientation unless disturbed by some externally imposed electric force. The polarization of the material characterizes the extent to which these domains are aligned. The polarization can be reversed by the application of an electric field of sufficient strength and polarity. In various embodiments, the ferroelectric polymer material may comprise a polyvinyl fluoride, a polyethylene fluoride, a polyvinyl chloride, a polyethylene chloride, a polyacrylonitrile, a polyamide, copolymers thereof, or combinations thereof. Polymer memories are sometimes referred to as plastic memories.

In an alternate embodiment, disk cache 140 may be another type of polymer memory such as, for example, a resistive change polymer memory. In this embodiment, the polymer memory may include a thin film of non-volatile polymer memory material sandwiched at the nodes of an address matrix, e.g., a polymer memory material between two address lines. The resistance at any node may be altered from a few hundred ohms to several megohms by applying an electric potential across the polymer memory material to apply a positive or negative current through the polymer material to alter the resistance of the polymer material. Potentially different resistance levels may store several bits per cell and data density may be increased further by stacking layers.

In another embodiment, disk cache 140 may be a flash electrically erasable programmable read-only memory (EEPROM), which may be referred to simply as a flash memory. In yet another embodiment, disk cache 140 may be a dynamic random access memory (DRAM) or a battery backed-up DRAM.

Although the scope of the present invention is not limited in this respect, disk memory 130 may be a mass storage device such as, for example, a hard disk memory having a storage capacity of at least about one gigabyte (GB). In various embodiments, disk memory 130 may be an electromechanical hard disk memory, an optical disk memory, or a magnetic disk memory. In one embodiment, disk cache 140 may have a storage capacity of at least about 100 megabytes. For example, disk cache 140 may have a storage capacity of about 500 megabytes (MB). Disk cache 140 may be block addressable/accessible, although the scope of the present invention is not limited in this respect.

Although the description makes reference to specific components of the system 100, it is contemplated that numerous modifications and variations of the described and illustrated embodiments may be possible. System 100 may be a portable personal computer (PC) such as, e.g., a notebook or laptop computer capable of wirelessly transmitting information. However, it is to be understood that embodiments of the present invention may be implemented in another wireless device such as, e.g., a cellular phone, a wireless personal digital assistant (PDA) or the like.

It should also be noted that the embodiments described herein may also be implemented in non-wireless devices such as, for example, a desktop PC, server, or workstation that is not configured for wireless communication.

A power source 150 may be used to provide power to system 100. The power source may change during operation of system 100. As an example, power source 150 may be either a direct current (DC) power source (e.g., a battery) or an alternating current (AC) power source (e.g., 60 Hz AC supplied by a power line), although the scope of the present invention is not limited in this respect. In addition, system 100 may operate in multiple power states, wherein system 100 has different modes of operation or uses different algorithms to operate, and the power consumption of system 100 may vary based on the mode of operation or algorithms used.

In one embodiment, system 100 may operate in a relatively higher power state while coupled to an AC power source and may operate in a relatively lower power state while coupled to a DC power source, wherein the power consumption of system 100 is less in the lower power state compared to the power consumption of system 100 in the higher power state. This may be the result of altering system operation based on the power source. For example, system 100 may be adapted to detect which power source is being used, and may be adapted to change its mode of operation or power state by altering the power settings of its components or by using power savings algorithms vs. using performance algorithms.

Alternatively, the user may select a particular power mode of operation or power state. For example, the user may select to have system 100 operate in a low power state to conserve power. System 100 may implement power savings algorithms to reduce the power consumption of system 100 or may implement performance algorithms to increase performance of system 100, which may come at the expense of increasing power consumption.

As another example, the type of DC power source may be different, e.g., system 100 may use a high performance battery or a low performance battery. When using the high performance battery, system 100 may use performance algorithms to increase the performance of system 100 and system 100 may use power savings algorithms to decrease power consumption when using the low performance battery.

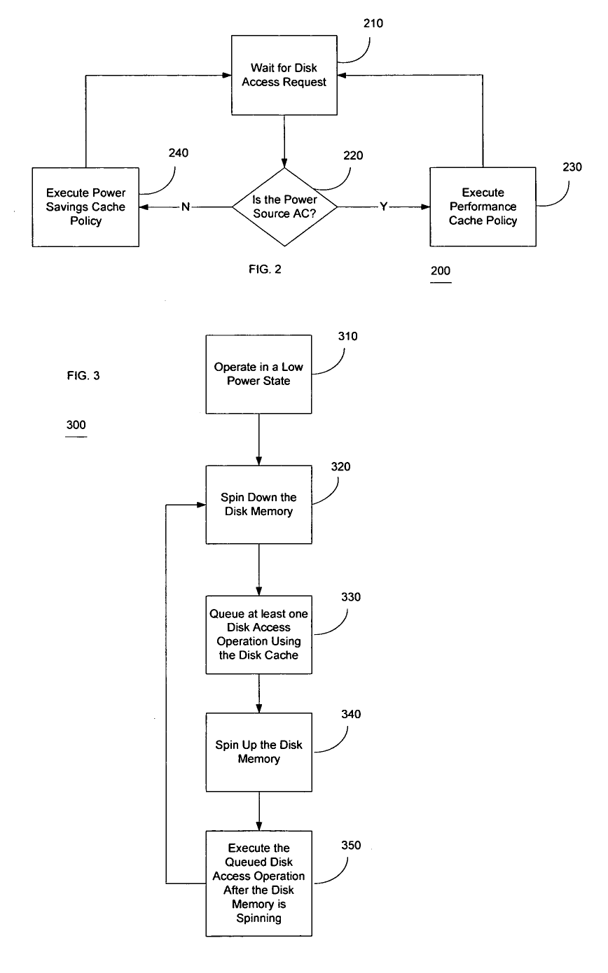

Turning to FIG. 2, what is shown is a flow diagram illustrating a method 200 to select or alter a cache policy based on the power source in accordance with an embodiment of the present invention. The methods discussed herein will be described with reference to system 100 of FIG. 1.

Method 200 may begin with waiting for a disk access request to be received by memory controller 120 (block 210). The disk access request may be a request to read information from disk memory 130 or a request to write information to disk memory 130. A disk read request may include a request to prefetch information from disk memory 130.

In response to the disk access request, system 100 may determine what power source is currently being used. For example, system 100 may detect whether an AC power source is used (diamond 220). If it is determined that an AC power source is used, then system 100 may execute a performance cache algorithm or policy (block 230). Otherwise, if it is determined that an AC power source is not used, e.g., a DC power source is used, then system 100 may execute a power savings cache algorithm or policy (block 240).

Method 200 illustrates an embodiment wherein when a disk access request (read or write) is received by memory controller 120, the power source of system 100 may be used to decide whether to use power optimized cache algorithms or performance optimized cache algorithms. This may be implemented as a choice of completely separate cache algorithms, or options within a single algorithm with decisions along the way to increase power savings or increase performance. Although the scope of the present invention is not limited in this respect, some of the decisions that may be different for power savings cache algorithms vs. performance cache algorithms include: when to prefetch and how much data to prefetch; when to write back dirty data from disk cache 140 to disk memory 130; when to allow a “lazy write” to operate or be enabled; when to “spin down” or “spin up” disk memory 130; or whether a given disk location in disk memory 130 should be cached at all.

A lazy write may refer to one method to write back dirty data from disk cache 140 to disk memory 130. A lazy write may include receiving a request to write data to disk memory 130 and in response to the write request, the write data may be written and temporarily stored or buffered in disk cache 140 and not immediately written to disk memory 130. Then, control may be returned to the user. At some later point in time, after it is determined that the system is idle, the dirty data may be written to disk memory 130. Dirty data may refer to information that is stored in disk cache 140, but has not yet been written to disk memory 130. A “flush” operation may refer to writing all of the dirty data in disk cache 140 to disk memory 130, to achieve coherency between disk memory 130 and disk cache 140. In other words, a flush operation may be performed in order to make sure that the contents of disk cache 140 and disk memory 130 are the same. A flush operation may include writing one or more dirty cache lines from disk cache 140 to disk memory 130.

Accordingly, in one aspect, method 200 illustrates an embodiment wherein the caching policy is selected upon each disk memory access. In an alternate embodiment, a unified algorithm with decision points within the algorithm that depend on power source may be used.

In another aspect, method 200 provides an adaptive disk caching algorithm that may increase power savings when system 100 is using battery power and may increase performance when using AC power. As an example, a simple selection of cache policy or algorithm based upon a power source may be used. The power source may be determined by monitoring a power source signal.

Although FIG. 2 illustrates a method to select or alter a cache policy based on power source, in another embodiment, the present invention may also include selecting or altering a cache policy based on power state, or based on a transition in power state or power source.

A power savings cache policy may implement cache algorithms that decrease power consumption by, e.g., reducing the amount of disk accesses to disk memory 130. This may be accomplished by attempting to satisfy as many disk read and write requests as possible using disk cache 140. If disk memory 130 is a rotating disk memory, reducing the number of disk accesses to disk memory 130 may reduce power consumption in system 100 since disk memory 130 may remain “spun down” a large percentage of the time during a low power state.

In one embodiment, a power savings cache policy may include an evict policy of the cache to favor evicting data that does not require the disk to be spun up. For example, the power savings cache policy may include an algorithm favoring “dirty evicts,” i.e., the eviction or deleting of dirty data from disk cache 140.

FIG. 3 illustrates a method 300 to decrease power consumption in system 100 in accordance with an embodiment of the present invention. Method 300 may begin with operating in a lower power state, e.g., when system 100 uses a DC power source (block 310). At some point in time, disk memory 130 may be spun down while system 100 is in the low power state (block 320).

Method 300 may further include, queuing or buffering at least one disk access request received by memory controller 120 using disk cache 140 while disk memory 130 is not spinning (block 330). For example, all write requests to write data to disk memory 130 may be queued or buffered by storing the write data for the write requests in the non-volatile disk cache 140 if disk memory 130 is spun down. This creates dirty data in disk cache 140 that may be written to disk memory 130 after disk memory 130 is spun up. In another example, if disk memory 130 is spun down, all prefetch requests to prefetch data from disk memory 130 may be queued or buffered by storing the prefetch request in the non-volatile disk cache 140 or by queuing the prefetch request in memory controller 120.

In order to reduce the amount of time disk memory 130 is spinning, disk memory 130 may be “spun up” in response to limited events (block 340). For example, a cache policy may include spinning up disk memory 130 only in response to a cache read miss, and then executing any queued or buffered disk access requests after disk memory 130 is spinning (block 350). In another example, since disk cache 140 has a limited capacity, only a limited number of disk write requests may be queued using disk cache 140, so if no more space exist in disk cache 140 to queue the write data for a disk write request, then disk memory 130 may be spun up and a flush operation may be executed. Also, any pending or deferred prefetch requests may also be executed while the disk is spinning to clear as many of the queued disk access requests as possible.

An example of a power savings cache policy is illustrated with reference to FIG. 3. In this example, the power savings cache policy may include one or more cache algorithms that include queuing at least one disk access operation using disk cache 140 while disk memory 130 is “spun down,” i.e., not spinning. The power savings cache policy may further include executing the queued disk access operation after disk memory 130 is spinning. The queued disk access operation may also be referred to as a pending or deferred disk access operation.

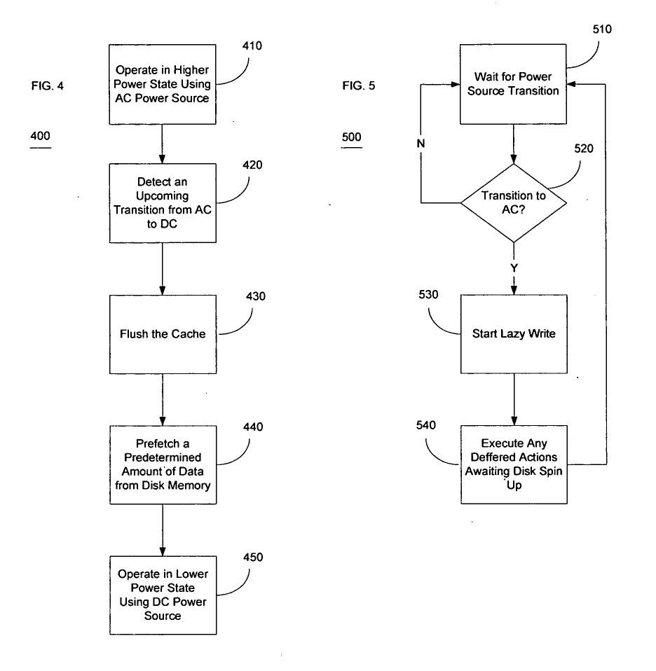

To decrease power consumption in a low power state, some tasks may be performed prior to the transition to the low power state. FIG. 4 is a flow diagram illustrating a method 400 to prepare disk cache 140 for operating in a low power mode of operation in accordance with an embodiment of the present invention.

Turning to FIG. 4, method 400 may begin with system 100 operating in a higher power state, e.g., operating in a power state using an AC power source (block 410). System 100 may have the ability to detect an upcoming or impending power state transition, e.g., a forthcoming transition from using an AC power source to using a DC power source (block 420). Either prior to, or after system 100 initiates the power source transition, system 100 may flush disk cache 140 (block 430) and may prefetch a predetermined amount of data from disk memory 130 to disk cache 140 (block 440). Prefetching may reduce the need to go to disk memory 130, since data requested for subsequent read requests may be available in disk cache 140. Flushing disk cache 140 may create more space for prefetch data and more space in disk cache 140 for queuing disk write requests.

Accordingly, method 400 may allow system 100 to set up disk cache 140 so as to reduce the number of disk accesses to disk memory 130, which may reduce power consumption in system 100. After flushing disk cache 140 and prefetching, system 100 may transition its operating mode to operate in a lower power state using a DC power source (block 450).

In one aspect, method 400 provides a method to detect an impending power source transition in system 100 and also illustrates actions that may be taken in response to the detecting of the impending power source transition.

Generally, when operating in the higher power state, e.g., when coupled to an AC power source, system 100 may implement a cache policy that may increase performance of system 100. In one embodiment, a performance based cache policy may include one or more cache algorithms that increases the number of cache hits. For example, disk memory 130 may be spun up often and information may be aggressively prefetched from the disk memory 130 to disk cache 140. By using aggressive or frequent prefetching, this may increase the number of cache hits which may increase system performance. In addition, frequent flushing of disk cache 140 may also be done to create more space for prefetching. This may also be advantageous in that it may set up the disk cache 140 for operation in a low power state should such a transition occur.

In addition, a performance cache policy may include enabling lazy write operations while operating in a higher power state and/or while coupled to an AC power source. Conversely, lazy write operations may be disabled while operating in a lower power state and/or while coupled to a DC power source.

FIG. 5 is a flow diagram illustrating a method 500 to detect a power source transition in accordance with an embodiment of the present invention. Method 500 illustrates a power transition and actions that system 100 may take in response to a transition from using a DC power source to an AC power source.

Method 500 may begin with waiting for a power source transition (block 510). System 100 may then detect a transition to an AC power source (diamond 520). System 100 may then enable or start lazy write operations (block 520). In addition, in response to the power source transition, system 100 may execute any deferred or queued actions awaiting disk spin up (block 530). For example, any queued actions that were deferred as a result of a power savings cache algorithm while system 100 was using a DC power source may be executed after a power source transition.

As may be appreciated from the discussion above, in one embodiment, a method to switch between a performance cache policy and a power savings cache policy based on a power source of a system is provided.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
altering a cache policy of a system in response to the system transitioning from a first power state to a second power state.

2. The method of claim 1, wherein altering includes switching from using a power savings cache policy to a performance cache policy in response to the system transitioning from using a direct current (DC) power source to using an alternating current (AC) power source.

3. The method of claim 1, wherein altering includes switching between a performance cache policy and a power savings cache policy and wherein power consumption of the system in the first power state is less than the power consumption of the system in the second power state.

4. The method of claim 3, wherein the system includes a non-volatile disk cache and a disk memory, wherein the disk cache is adapted to cache information for the disk memory and wherein the power savings cache policy and the performance cache policy are cache policies used by the disk cache.

5. The method of claim 4, wherein the power savings cache policy includes:
queuing all write requests to write data to the disk memory by storing the write data for the write requests in the non-volatile disk cache if the disk memory is spun down;
spinning up the disk memory in response to a cache read miss; and
writing the data for the write requests to the disk memory from the non-volatile disk cache in response to the cache read miss and while the disk memory is spinning.

6. The method of claim 4, wherein the power savings cache policy includes
queuing at least one disk memory access operation using the non-volatile disk cache if the disk memory is not spinning; and
executing the at least one disk memory in response to a cache read miss.

7. The method of claim 6, wherein the at least one disk memory access operation is a write request to write data to the disk memory.

8. The method of claim 6, wherein the at least one disk memory access operation is a prefetch operation to prefetch data from the disk memory to the non-volatile disk cache.

9. The method of claim 4, wherein the power savings cache policy includes:
spinning up the disk memory only in response to a cache read miss.

10. The method of claim 4, wherein the power savings cache policy includes:
queuing a prefetch request if the disk memory is spun down;
prefetching data from the disk memory to the disk cache to satisfy the queued prefetch request only in response to a cache read miss; and
spinning up the disk memory in response to the cache read miss.

11. The method of claim 4, wherein the performance cache policy includes:
spinning up the disk memory in response to the system transitioning from the first power state to the second power state; and
flushing the disk cache after the disk memory is spinning and after the system transitions to the second power state from the first power state.

12. The method of claim 4, wherein the performance cache policy includes:
spinning up the disk memory in response to the system transitioning from the first power state to the second power state; and
writing at least one dirty cache line from the non-volatile disk cache to the disk memory after the system transitions to the second power state from the first power state.

13. The method of claim 4, wherein the performance cache policy includes:
flushing the disk cache; and
prefetching data from the disk memory to the disk cache.

14. The method of claim 3, wherein the power savings cache policy includes disabling a lazy write operation.

15. The method of claim 14, wherein the performance cache policy includes enabling the lazy write operation after the system transitions to the second power state from the first power state.

16. The method of claim 1, wherein altering includes detecting a change in power state, wherein detecting includes determining if the system transitioned from using a direct current (DC) power source to using an alternating current (AC) power source.

17. A method, comprising:
switching between a performance cache policy and a power savings cache policy.

18. The method of claim 17, wherein switching includes switching between a performance cache policy to a power savings cache policy based on a power source of a system.

19. The method of claim 18, wherein the system consumes less power using the power savings cache policy compared to using the performance cache policy.

20. The method of claim 18, wherein switching includes switching from the power savings cache policy to the performance cache policy if the system switches from using a direct current (DC) power source to using an alternating current (AC) power source.

21. The method of claim 18, wherein the system includes a non-volatile disk cache and a disk memory, wherein the non-volatile disk cache caches information for the disk memory and wherein the non-volatile disk cache uses either the power savings cache policy or the performance cache policy depending on the power source used by the system.

22. A method, comprising:
detecting an impending transition of a system from a first power state to a second power state; and
flushing the cache memory of the system in response to the detecting of the impending transition.

23. The method of claim 22, further comprising:
prefetching a predetermined amount of data from a disk memory to the cache memory in response to the detecting.

24. The method of claim 22, further comprising:
spinning up a disk memory in response to the detecting, wherein the power consumption of the system in the first power state is greater than the power consumption of the system in the second power state and wherein flushing the cache memory includes flushing a disk cache memory of the system after the disk memory of the system is spinning.

25. A method, comprising:
detecting an impending transition of a system from a first power state to a second power state; and
writing at least one dirty cache line from a cache memory of the system to a disk memory of the system in response to the detecting of the impending transition.

26. The method of claim 25, further comprising:
prefetching a predetermined amount of data from the disk memory to the cache memory in response to the detecting.

27. The method of claim 25, further comprising:
spinning up a disk memory in response to the detecting, wherein the power consumption of the system in the first power state is greater than the power consumption of the system in the second power state and where writing at least one dirty cache line includes writing the at least one dirty cache line from the cache memory of the system to the disk memory of the system after the disk memory is spinning.

28. A method, comprising:
detecting an impending transition of a system from using a first power source to a using second power source; and
prefetching a predetermined amount of information from a storage memory to a cache memory in response to the detecting of the impending transition.

29. The method of claim 28, further comprising:
flushing the cache memory of the system in response to the detecting and prior to prefetching and the transition of the system to the second power source, wherein the storage memory is a disk memory, the cache memory is a polymer disk cache memory, the first power source is an alternating current (AC) power source, and the second power source is a direct current (DC) power source.

30. A system, comprising:
a memory controller to alter a cache policy of the system in response to the system transitioning from a first power state to a second power state.

31. The system of claim 30, further comprising:
a disk memory coupled to the memory controller; and
a non-volatile disk cache memory coupled to the memory controller, wherein the non-volatile disk cache memory is adapted to cache information for the disk memory, wherein an access time of the non-volatile disk cache memory is less than an access time of the disk memory, and wherein the storage capacity of the non-volatile disk cache memory is less than the storage capacity of the disk memory.

32. The system of claim 31, wherein the storage capacity of the disk memory is at least about one gigabyte and the storage capacity of the non-volatile disk cache memory is at least about 100 megabytes.

33. The system of claim 31, wherein the non-volatile disk cache memory is a polymer memory.

34. The system of claim 31, wherein the non-volatile disk cache memory is a ferroelectric memory.

35. The system of claim 31, wherein the non-volatile disk cache memory is a resistive change memory.

36. The system of claim 31, wherein the non-volatile disk cache memory is a battery backed-up DRAM or a flash electrically erasable programmable read-only memory (EEPROM).

37. A system, comprising:
a processor;
a wireless interface coupled to the processor;
a memory controller to alter a cache policy of the system in response to the system transitioning from a first power state to a second power state, wherein the memory controller is coupled to the processor;
a disk memory coupled to the memory controller; and
a non-volatile disk cache coupled to the memory controller, wherein the cache policy is used by the non-volatile disk cache to cache information for the disk memory.

38. The method of claim 37, wherein the memory controller is adapted to switch between a performance cache policy and a power savings cache policy, wherein power consumption of the system in the first power state is less than the power consumption of the system in the second power state and wherein the power savings cache policy and the performance cache policy are cache policies used by the non-volatile disk cache.

39. The system of claim 37, wherein the system is a portable computer.
